(19) United States
(12) Patent Application Publication
(10) Pub. No.: US 2019/0047882 A1
(43) Pub. Date: Feb. 14, 2019

(54) COATING LIQUID PREPARING DEVICE AND COATING DEVICE

(71) Applicant: Tomokazu KANDA, Sayama-shi (JP)

(72) Inventor: Tomokazu KANDA, Sayama-shi (JP)

(21) Appl. No.: 16/080,148

(22) PCT Filed: Mar. 4, 2016
(86) PCT No.: PCT/JP2016/056710

§ 371 Date: Aug. 27, 2018

(51) Int. Cl. C02F 1/48; B05B 9/04; C02F 1/32; C02F 9/00; C09D 1/00; C09D 5/16

(52) U.S. Cl. CPC C02F 1/48; B05B 9/0403; C02F 1/32; C02F 9/00; C09D 1/00; C02F 2305/12; C02F 2201/002; C02F 2201/32; C02F 2201/48; C02F 2301/08; C09D 5/16

(57) ABSTRACT

To provide a coating liquid that prevents surfaces of vehicles, walls, or the like from becoming dirty easily and that allows dirt to be easily removed even if the surfaces become dirty.

A coating liquid preparing device 1 is provided with a cylinder device 5, a liquid activation device 8, and a connection flow path 12 which connects the cylinder device and the liquid activation device. The cylinder device 5 includes a cylindrical body whose both ends are closed, filters are respectively disposed near both ends of the cylindrical body inside the cylindrical body, and ceramic composites are provided between the filters. Also, a liquid ejection pipe that penetrates through the filter near one end of the cylindrical body is provided at one end of the cylindrical body, a liquid outlet is provided at the other end of the cylindrical body, and the liquid ejection pipe has a liquid inlet. Moreover, the liquid activation device 8 has a flow path through which a liquid flows, at least a pair of permanent magnets that is provided so as to face each other, having the flow path interposed therebetween, and an ultraviolet ray irradiation means that emits ultraviolet rays onto the liquid flowing through the flow path.

### TECHNICAL FIELD

The present invention relates to a coating liquid preparing device capable of preventing surfaces of vehicles, walls, or the like from becoming dirty easily and enabling dirt to be easily removed even if the surfaces become dirty, and a device and a method used for coating surfaces of objects (vehicles, walls, or the like) with the coating liquid.

### BACKGROUND ART

Various cleaning devices and cleaning liquids have been conventionally proposed as means for removing dirt adhering to vehicles, walls, and the like.

However, vehicles, outer walls of various structures, or the like which are used outdoors are constantly exposed to the outside air, so that even if the dirt is removed, the vehicles or the outer walls become dirty again within an extremely short period of time. As a result, there are problems in that the vehicles or the outer walls are forcedly re-cleaned within a short period of time. In addition, the dirt adhering to the vehicles or the outer walls which are constantly exposed to the outside air is so persistent that it cannot be easily removed, so there is a problem that labor and time are required for cleaning. In addition, when dirt adhering to a surface of a body of a vehicle is removed by being scrubbed with a scrubbing-brush or the like, there is a possibility that scratches occur on the body, and therefore there is a problem in that the dirt on the surface of the body in the case of cars (for example, a luxury foreign car, a sports, car, a vintage car) to be carefully handled, or the like cannot be easily removed.

Therefore, among participants involved in cleaning and owners of vehicles or the like, means for preventing surfaces of vehicles, walls, or the like from becoming dirty and for easily removing the dirt even if the surfaces become dirty have been strongly demanded over the years.

### CITATION LIST

### Patent Literature

Patent Literature 1: WO 2010/035421 A1

### SUMMARY OF INVENTION

### Technical Problem

In view of the above-described problems and long-standing demands, it is an object of the present invention to provide a coating liquid preparing device capable of preventing surfaces of vehicles, walls, or the like from becoming dirty easily and enabling dirt to be easily removed, a coating device, and a coating method.

### Solution to Problem

To accomplish the above-described object, a coating liquid preparing device includes: a cylinder device in which a liquid as a source of a coating liquid to be prepared can flow; a liquid activation device in which the liquid can flow; and a connection flow path which connects one of the cylinder device and the liquid activation device to the other of the cylinder device and the liquid activation device,

wherein the cylinder device includes a cylindrical body (transversal cylindrical body or standing cylindrical body) whose both ends are closed, filters are respective disposed near both ends of the cylindrical body inside the cylindrical body, ceramic composites are provided between the filters, a liquid ejection pipe that penetrates through the filter near one end of the cylindrical body is provided at one end of the cylindrical body, a liquid outlet is provided at the other end of the cylindrical body, the liquid ejection pipe has a liquid inlet, the liquid ejection pipe has a leading end closed while having the liquid inlet, and a side wall of a pipe has one or two or more liquid ejection holes, and

the liquid activation device has a flow path through which the liquid flows, at least a pair of permanent magnets that is provided so as to face each other, having the flow path interposed therebetween, and an ultraviolet ray irradiation means that emits ultraviolet rays onto the liquid flowing through the flow path.

In the cylinder device, preferably,

the cylindrical body whose both ends are closed may have the liquid outlet and the liquid inlet, and the filters may be provided on the liquid outlet and the liquid inlet.

In the liquid activation device, preferably,

an ultraviolet ray irradiation portion of the ultraviolet ray irradiation means may be disposed within the flow path.

In the coating liquid preparing device, preferably, a pump and circulation flow paths which circulate a liquid into the cylinder device and the liquid activation device which are connected by the connection flow path are provided.

Furthermore, the above-described object is accomplished by a coating device including:

the above-described coating liquid preparing device; and

a liquid ejection device which sprays a coating liquid prepared by the coating liquid preparing device onto a coating object.

The liquid activation device included in the present invention may have the following characteristics.

That is, at least a pair of permanent magnets having N poles and S poles facing each other is disposed having a flow path interposed therebetween, a pair of concave type yokes magnetically contacting surfaces opposite to an opposing surfaces of the pair of permanent magnets and molded with a magnetic metal or a magnetic ceramic is disposed at a predetermined interval so as to face each other, copper, silver, and gold alone or composites of these metals are plated on the inside of the concave type yoke including the interval between the pair of concave type yokes except for the contact surfaces with the pair of permanent magnets, or a nonmagnetic conductive metal layer constituted by a composite metal plate to which the thin plate of these metals is bonded is attached to the inside of the concave type yoke, and potential of inner surfaces of the pair of concave type yokes is increased to pass water into the flow path so as to repel an electromotive current, which is generated in a direction perpendicular to a direction of the flowing water and a direction of lines of magnetic force between the pair of permanent magnets, toward the flow path by the potential of the inner surface of the yoke, thereby allowing electrons to act on the flowing water in the flow path and the magnetic force between the pair of permanent magnets to act thereon to perform the cleaning treatment.

As a result, there is provided a method for activating water which performs the magnetic activation by the permanent magnet and the electrochemical activation by electrons, and is more efficient, realizes higher activation, and has no danger of water leakage due to the synergistic action of the magnetic force and the electrons, as compared to the activation method of only the magnetic force.

In addition, at least a pair of concave type yokes molded with a magnetic metal or a magnetic ceramic, an N pole of a permanent magnet provided so as to be in magnetic contact with an inner surface of one of the pair of concave type yokes, and an S pole of the permanent magnet provided so as to be in magnetic contact with an inner surface of the other of the concave type yokes are provided, wherein the pair of concave type yokes is arranged at a predetermined interval so that the N pole and the S pole face each other, copper, silver, and gold alone or composites of these metals are plated on the inside of the concave type yoke including the interval between the pair of concave type yokes except for the contact surface with the N pole and the S pole or a nonmagnetic conductive metal layer constituted by a composite metal plate to which the thin plate of these metals is bonded is attached to the inside of the concave type yoke, and the nonmagnetic flow path is provided between the N pole and the S pole facing each other to pass water in a direction perpendicular to a direction of lines of magnetic force from the N pole to the S pole in the flow path so as to activate the passing water.

As a result, there is provided a device for activating water which performs the magnetic activation by the permanent magnet and the electrochemical activation by electrons, and is more efficient, realizes higher activation, and has no danger of water leakage due to the synergistic action of the magnetic force and the electrons, as compared to the activation method of only the magnetic force.

In addition, the activation device has a housing that houses the pair of concave type yokes including a part of the flow path, and the outside of the housing is covered with a chromium metal plate plated with chromium which is a ferrodiamagnetic metal.

As a result, it is possible to realize the water activation device capable of enclosing the lines of magnetic force into the inside without leaking the lines of magnetic force to the outside, and allowing the magnetic force to act on the flowing water more effectively.

In addition, the nonmagnetic conductive metal layer of the activation device is constituted by the composite plating or the composite metal plate of metals having different potentials, and a metal having a high potential is positioned on the flow path side.

As a result, it is possible to realize the water activation device capable of accelerating the emission of electrons by the contact cell action and allowing electrons to act on the flowing water more effectively.

Also, the flowing water passing through the flow path of the activation device is not in contact with the concave type yoke and the nonmagnetic conductive metal layer.

As a result, it is possible to realize the water activation device having no risk of water leakage.

In addition, in the case of coating the coating objects such as the body of the vehicle and the outer wall of the building using the above-described coating device, the coating objects (structures before the coating) are subjected to “cleaning treatment” using a predetermined cleaning liquid agent before the coating. That is, it is preferable to perform the cleaning treatment using the cleaning liquid agent to be described below, and then perform the coating on the cleaned object using the coating device.

The above-described “cleaning treatment” includes a cleaning process of cleaning the structures with one or more cleaning liquid agents selected from the group consisting of the following (1) to (4).

(1) A cleaning liquid agent containing sodium hypochlorite, sodium hydroxide, sodium carbonate, a nonionic surfactant, and glycine and having a pH of 8 to 12.

(2) A cleaning liquid agent containing sodium hydrogen fluoride and a chelating agent and having a pH of 4 to 6.

(3) A cleaning liquid agent containing sodium hypochlorite and sodium carbonate, not containing sodium hydroxide and having a pH of 8 to 12.

(4) A cleaning liquid agent containing a nonionic surfactant, an alkali builder, a chelating agent, and a metal sequestering agent (excluding the alkali builder) and having a pH of 8 to 12.

In the “cleaning treatment” using the above-described cleaning liquid agent, the structure (the object to be coated later) is a structure that is dirty due to fungi and/or bacteria, and in the cleaning process prior to the coating processing, it is also preferable to use the cleaning liquid agent (1).

In the above-described “cleaning treatment”, the structure is a structure that is dirty due to fungi and/or bacteria and rust, and in the cleaning process prior to the coating processing, it is also preferable to use the cleaning liquid agents (1) and (2).

In the above-described “cleaning treatment”, the structure is a structure that is dirty due to fungi and/or bacteria, rust, and oil, and in the cleaning process prior to the coating processing, it is also preferable to use the cleaning liquid agents (1), (2), and (4).

In the above-described “cleaning treatment”, the structure is a structure that is dirty due to fungi and/or bacteria and oil, and in the cleaning process prior to the coating processing, it is also preferable to use the cleaning liquid agents (1) and (4).

In the above-described “cleaning treatment”, the structure is a wooden structure that is dirty due to fungi and/or bacteria, and in the cleaning process prior to the coating processing, it is also preferable to use the cleaning liquid agent (3).

In the above-described “cleaning treatment”, the structure is a wooden structure that is dirty due to fungi and/or bacteria, rust, and marks from the sunlight, and in the cleaning process prior to the coating processing, it is also preferable to use the cleaning liquid agents (2), (3), and (4).

In the above-described “cleaning treatment”, the structure is a concrete-made structure that is dirty due to fungi and/or bacteria, and in the cleaning process prior to the coating processing, it is also preferable to use the cleaning liquid agent (1).

In the above-described “cleaning treatment”, the structure is a concrete-made structure that is dirty due to fungi and/or bacteria, rust, and oil, and in the cleaning process prior to the coating processing, it is also preferable to use the cleaning liquid agents (1), (2), and (4).

In the above-described “cleaning treatment”, the structure is a stone or tile-made structure that is dirty due to fungi and/or bacteria, and in the cleaning process prior to the coating processing, it is also preferable to use the cleaning liquid agents (1) and (2).

In the above-described “cleaning treatment”, the structure is a stone or tile-made structure that is dirty due to fungi and/or bacteria, rust, and oil, and in the cleaning process prior to the coating processing, it is also preferable to use the cleaning liquid agents (1), (2), and (4).

In the above-described “cleaning treatment”, it is also preferable to have a process of recognizing the dirt of the structure prior to the cleaning process, and it is also preferable to perform the cleaning process by selecting the cleaning liquid agent according to the type of recognized dirt.

In the above-described “cleaning, treatment”, it is also preferable that the cleaning process is a process of bringing the cleaning liquid agent into contact with the structure and then washing the structure with water.

In the above-described “cleaning treatment”, it is also preferable that the contact time between the structure and the cleaning liquid agent is 20 minutes or more.

### Advantageous Effects of Invention

By spraying the coating liquid prepared by the present invention onto the surfaces of various structures such as the body of the vehicle and the outer wall of the building to coat the surfaces of the structures, it is possible to prevent the dirt on the surfaces (coated portions) of the structures.

In addition, even if various structures such as the body of the vehicle and the outer wall of the building are exposed to the outside air over a long period of time and attached with dirt such as mold, it is possible to easily remove the dirt by the coating effect.

### BRIEF DESCRIPTION OF DRAWINGS

FIG. 1 is a diagram showing a schematic configuration of a coating liquid preparing device and a coating device according to the present invention.

FIG. 2 is a cross-sectional view showing a horizontal type cylinder device of the present invention.

FIG. 3 is a cross-sectional view taken along line A-B of a cylinder device shown in FIG. 2.

FIG. 4 is a cross-sectional view showing a vertical type cylinder device of the present invention.

FIG. 5 is a diagram showing a schematic configuration of a liquid activation device of the present invention.

FIG. 6 is a cross-sectional perspective view showing an inner configuration of the liquid activation device of the present invention.

FIG. 7 is a cross-sectional view taken along line V-V of the liquid activation device shown in FIG. 5.

### DESCRIPTION OF EMBODIMENTS

(Schematic Configuration of Coating Liquid Preparing Device and Coating Device)

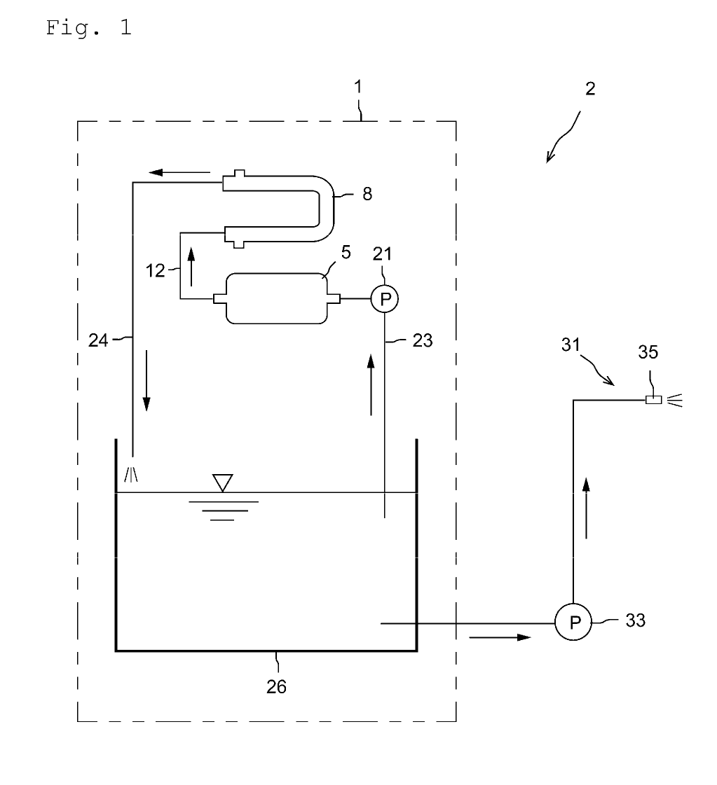

FIG. 1 shows a schematic configuration of a coating device including a coating liquid preparing device according to the present invention.

As shown in FIG. 1, a coating liquid preparing device 1 according to the present invention includes a cylinder device 5 in which a liquid can flow, a liquid activation device 8 in which a liquid can flow, a connection flow path 12 which connects an outlet of one of the cylinder device 5 and the liquid activation device 8 to an inlet of the other thereof, a pump 21 and circulation flow paths 23 and 24 which circulate a liquid so that the liquid repeatedly passes through the cylinder device 5 and the liquid activation device 8 connected by the connection flow path 12, and a tank 26 which stores a coating liquid during preparation and the generated coating liquid.

In addition, as shown in FIG. 1, the coating device 2 according to the present invention includes the coating liquid preparing device 1 having the above-described structure and a liquid ejection device 31 which ejects the coating liquid prepared by the coating liquid preparing device 1 onto a coating object. The liquid ejection device 31 is configured to include a pump 33, an ejection nozzle 35, and the like.

Representative examples of “solution” and “liquid” mentioned in this application, that is, representative examples of the liquid which is a source of the coating liquid may include “water” such as tap water. However, the liquid to which the present invention can be applied is not necessarily limited to water such as tap water, but a liquid containing water as a main ingredient is widely used. Examples of the liquid other than water to which the present invention can be applied may include a cleaning liquid containing water as a main ingredient and a chemical liquid for cleaning.

In the present invention, a source liquid such as the tap water and the cleaning liquid is pumped by using the pump 21. The liquid pumped by the pump passes through an inside of a cylindrical body (cylinder) of the cylinder device 5, passes through the flow path in the liquid activation device 8 via the connection flow path 12, and then repeatedly passes through the cylinder device 5 and the liquid activation device 8 via the circulation flow paths 23 and 24.

In this way, when the liquids such as the tap water and the cleaning liquid is pumped and is repeatedly circulated through the circulation paths 23 and 24, the liquid repeatedly passes through the cylinder device 5 and the liquid activation device 8. During the process, the source liquid such as the tap water and the cleaning liquid is changed into the coating liquid. That is, by circulating the source liquid such as the tap water and the cleaning liquid using the coating liquid preparing device 1, the coating liquid is prepared.

In this embodiment, as shown in FIG. 1, the cylinder device 5 is disposed on an upstream side and the liquid activation device 8 is disposed on a downstream side, but contrary to this, the liquid activation device 8 may be disposed on the upstream side and the cylinder device 5 may be disposed on the downstream side, and the liquid activation device 8 and the cylinder device 5 may be connected by the connection flow path 12.

The coating liquid prepared by the coating liquid preparing device 1 is stored in the tank 26, and is ejected onto a coating object such as the body of the vehicle and the outer wall of the building by the liquid ejection device 31 including a pump 33, an ejection nozzle 35, or the like.

The object onto which the coating liquid is sprayed is not particularly limited, and specific examples of the object may include a body of various moving bodies such as a vehicle, a ship, and an aircraft, an outer wall of a permanent structure such as a building, a window which includes surface portions of machinery or various structures such as a wall body exposed to the outside air and a transmitting portion of glass or transparent resin, or the like.

(Configuration of Cylinder Device)

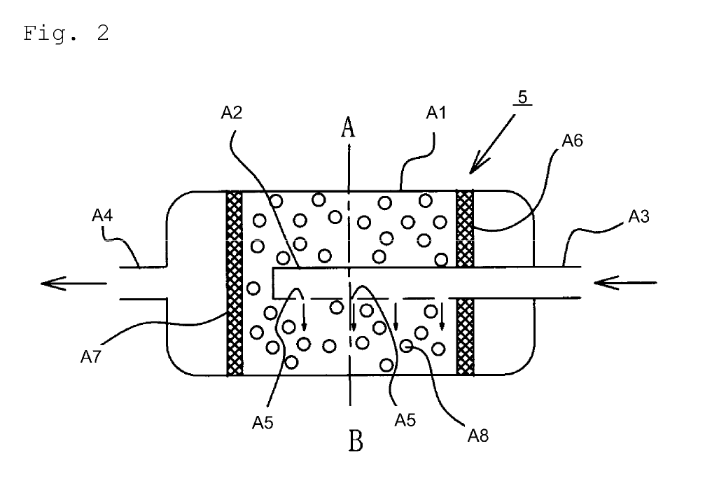

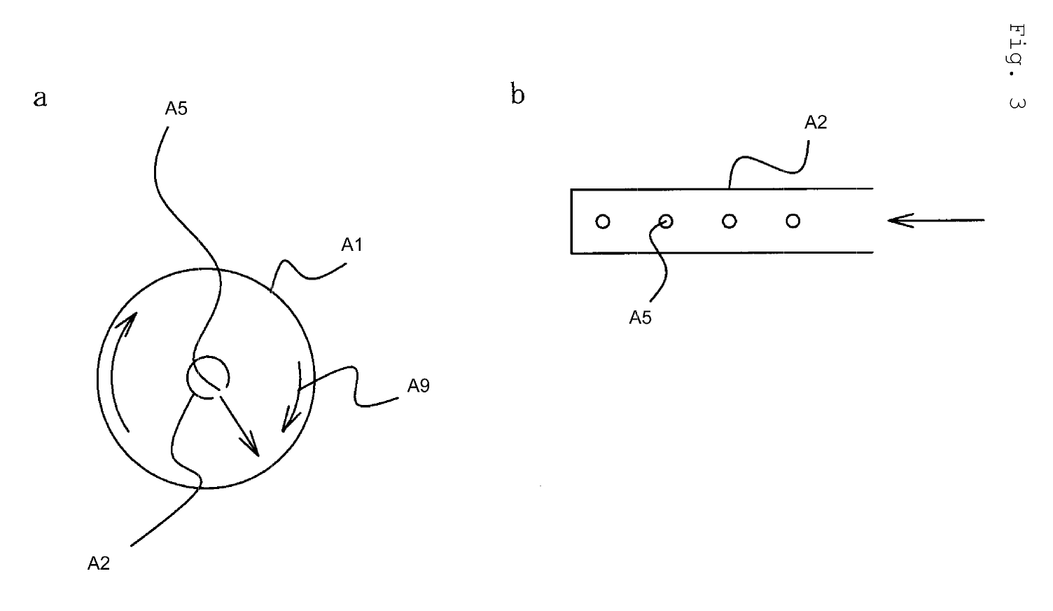

Next, a specific embodiment of the “cylinder device” that is a part of the coating liquid preparing device will be described with reference to FIGS. 2 and 3. The cylinder device is a device capable of preparing a slightly water-soluble silicon oxide solution.

FIG. 2 is a cross-sectional view showing a horizontal type cylinder device. In FIG. 2, the cylinder device is a so-called horizontal type cylinder device 5 which is a type disposed laterally and used, and includes a cylindrical body Al whose both ends are closed, that is, a cylinder A1 and in the cylindrical body A1, filters A6 and A7 are each provided near both end portions.

A ceramic composite A8 is provided between the filters A6 and A7, and the ceramic composite A8 is preferably a granular material.

Although a filling factor of the ceramic composite A8 is arbitrary, the filling factor is preferably 20% to 80%, more preferably 30% to 70%, and most preferably about 50%.

The filters A6 and A7 are preferably meshes which are fine enough not to pass particles of the ceramic composite A8.

The cylinder device 5 has a liquid inlet A3 and a liquid outlet A4 provided at both ends thereof, in which the liquid inlet A3 is provided at one end of the liquid ejection pipe A2. That is, the liquid ejection pipe A2 is provided at one end of the cylindrical body and made of a pipe penetrating through the filter A6 in the vicinity of the one end side of the cylindrical body and extends to the vicinity of the filter A7 of the other end of the cylindrical body. The liquid flowing out from the liquid outlet A4 flows through the connection flow path and flows into an inlet B61 of a flow path B1 included in a liquid activation device B12 to be described later.

In addition, as described above, the liquid ejection pipe A2 has the liquid inlet A3, has a leading end closed, and a side wall of the pipe is provided with one or two or more liquid ejection holes A5. As shown in FIG. 3, when an angle of the liquid ejection hole A5 is set to be 45° downward with respect to the vertical, the ejection liquid preferably rotates to maintain the particles of the ceramic composite A8 in a floating state, but is not particularly limited thereto.

For example, when tap water is introduced from the liquid inlet A3 of the liquid ejection pipe A2, the horizontal type cylinder device 5 can rotate the tap water ejected from the liquid ejection hole A5 to satisfactorily float the particles of the ceramic composite A8.

The particles of the ceramic composite A8 used in the present invention are composed of a ceramic composite obtained by sintering a polymeric initial condensate of silicon dioxide and an electric stone, and are dispersed in a liquid, and if the particles of the ceramic composite A8 are mechanically stimulated, silicon oxide is eluted to obtain a slightly water-soluble silicon oxide solution. In addition, the slightly water-soluble silicon oxide solution concentrated is obtained by circulating the slightly water-soluble silicon oxide solution through the cylinder device.

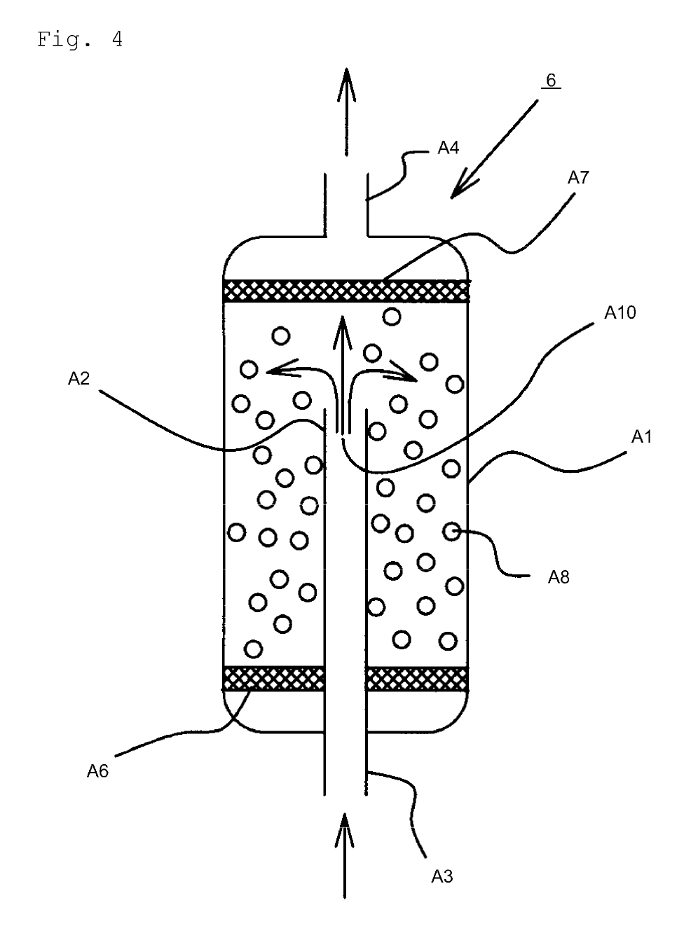

FIG. 4 s a cross-sectional view showing a vertical type cylinder device, which has substantially the same structure as the cylinder device shown in FIG. 2. However, the vertical cylinder device differs not only in that the horizontal type cylinder device 5 shown in FIG. 2 is disposed vertically but also in that the leading end portion of the liquid ejection pipe A2 is opened and the liquid ejection hole A5 is not provided on the pipe wall.

Therefore, in the vertical type cylinder device 6 shown in FIG. 3, the cylinder device 6 is arranged vertically and the liquid introduced from the liquid inlet A3 of the liquid ejection pipe A2 is ejected from an opening of the leading end of the liquid election pipe A2, and rotates up and down to make the particles of the ceramic composite A8 in a floating state. The slightly water-soluble silicon oxide solution thus obtained is taken out from the liquid outlet A4 of the cylinder device.

(Schematic Configuration of Liquid Activation Device)

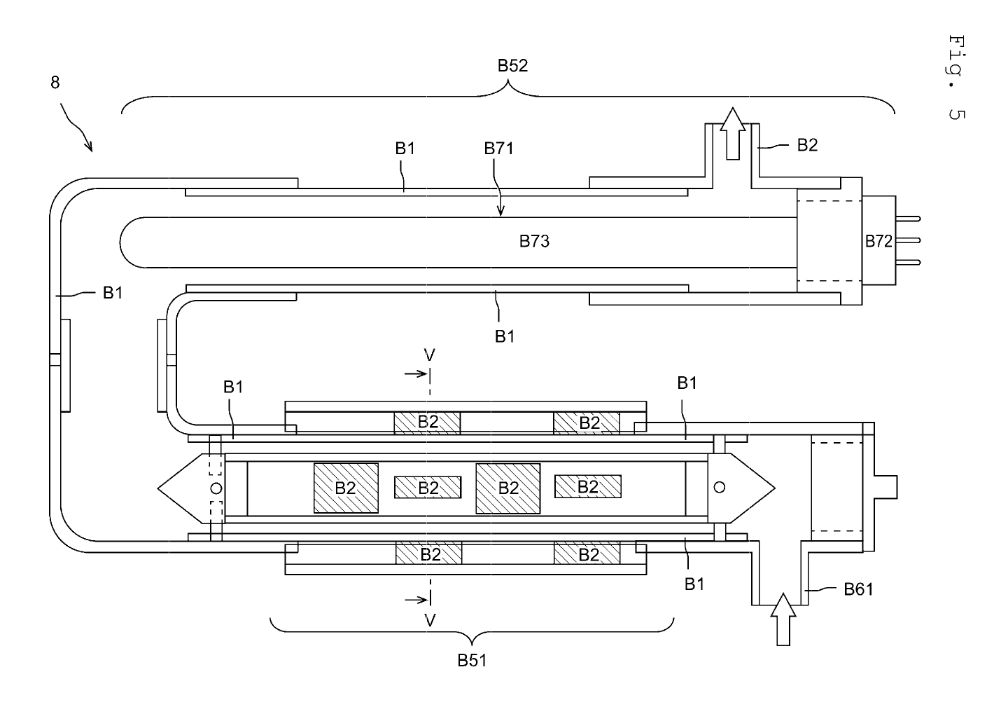

Next, a specific embodiment of the “liquid activation device” that is a part of the coating liquid preparing device will be described with reference to FIGS. 5 to 7.

FIG. 5 is a diagram showing a schematic configuration of the liquid activation device of the present invention.

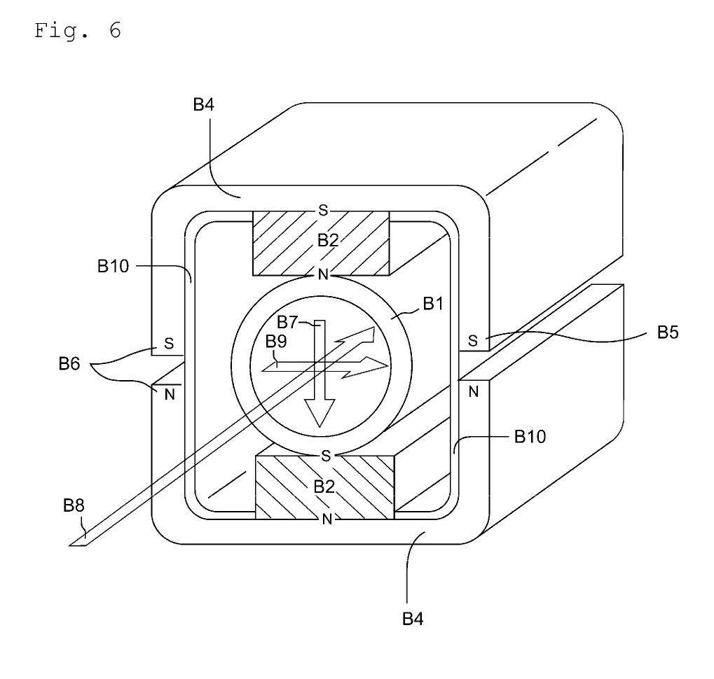

FIG. 6 is a cross-sectional perspective view showing an inner structure or a first liquid activation portion B51.

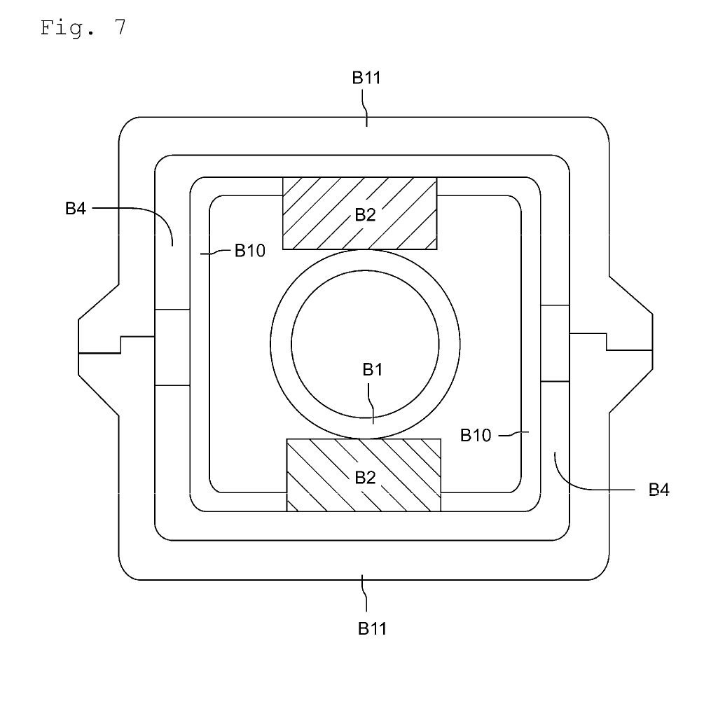

FIG. 7 is a cross-sectional view taken along line V-V of the liquid activation device shown in FIG. 5

As shown in FIG. 5, the liquid activation device B12 includes:

a flow path B1 which circulates a liquid flowing from the cylinder device via the connection floe path,

a first liquid activation portion B51 (magnetic processing portion) including a plurality of permanent magnets B2, and

a second liquid activation portion B52 (ultraviolet ray irradiation portion) including a UV lamp B71.

Representative examples of the liquid to be activated by using the liquid activation device B12 may include “water”. However, the liquid to which the present invention can be applied is not necessarily limited to water, but a liquid containing water as a main ingredient is widely used. Examples of the liquid other than water to which the present invention can be applied may include a cleaning liquid containing water as a main ingredient and a chemical liquid for cleaning.

In this embodiment, as shown in FIG. 5, the flow path B1 is constituted by a pipe formed so as to be bent in a substantially U-shape. An inlet B61 and an outlet B62 of the liquid to be activated are provided in the flow path B1. The liquid to be activated is pumped toward the inlet B61 of the flow path B1 by using the pump or the like. While the liquid introduced from the inlet B61 into the flow path B1 flows into the flow path, the liquid is subjected to the magnetic treatment by the permanent magnet B2 in the first liquid activation portion B51 and irradiated with ultraviolet rays from the UV lamp B71 in the second liquid activation portion B52, such that the liquid finally becomes an activated liquid and flows out from the outlet B62. As shown in FIG. 1, the liquid flowing out from the outlet B62 is temporarily stored in the tank 26 via the circulation path 24, and again flows into the cylindrical body A1 of the cylinder device 5 via the circulation path 23 by the pumping.

In the present embodiment, a pipe formed in a substantially U-shape as a representative example of the flow path B1 is adopted, but the shape of the flow path is not particularly limited as long as the liquid can flow through the flow path and the first and second liquid activation portions may be provided in the flow path. For example, it is possible to adopt various shapes such as an L-shape, a curved shape, a straight shape (a shape that is not bent), besides a shape bent into the substantially U-shape as shown in FIG. 5.

In the first liquid activation portion B51, six sets of a pair of permanent magnets B2 and B2 disposed so as to face each other having the flow path B1 interposed therebetween are provided. That is, in the first liquid activation portion B51 shown in FIG. 5, on the right of the drawing, four permanent magnets B2 face each other at 90° intervals (that is, two pairs are disposed). On the left of the drawing, a pair of permanent magnets B2 is disposed to face each other Further, on the left of the drawing, four permanent magnets B2 are disposed to face each other at 90° intervals (that is, two pairs are disposed). Further, on the left of the drawing, a pair of permanent magnets B2 is disposed to face each other. Therefore, in the present embodiment, in the first liquid activation portion B51, a total of twelve (six pairs) of permanent magnets 2 are disposed to face each other having the flow path B1 interposed therebetween. The type of the permanent magnet usable in the present invention is not particularly limited, and for example, Nd—Fe—B based magnets can be used.

The second liquid activation portion B52 is provided with an ultraviolet (UV) lamp B71 for applying ultraviolet rays to the liquid flowing through the flow path B1. The UV lamp B71 is an example of ultraviolet ray irradiation means. The UV lamp B71 is attached so that its ultraviolet ray irradiation portion B73 is positioned inside the flow path B1.

In the present embodiment, the first liquid activation portion B51 is provided between the inlet B61 and the outlet B62 of the flow path B1 and is provided to be close to the inlet B61. In addition, the second liquid activation portion B52 is provided between the inlet B61 and the outlet B62 of the flow path B1 and is provided to be close to the outlet B62. However, a layout of the first and second liquid activation portions B51 and B52 is not limited to those shown. For example, contrary to the layout shown in FIG. 5, the first liquid activation portion B51 may be disposed to be close to the outlet B62 and the second liquid activation portion B52 may be disposed to be close to the inlet B61, respectively.

In addition, in the embodiment to be described later, although the liquid to be treated passes through the liquid activation device B12 one pass (only once), the flow path B1 may be configured so that the liquid can be circulated. This makes it possible to repeat the magnetic treatment and the ultraviolet ray irradiation with respect to the liquid to be treated.

Hereinafter, the configuration of each portion of the liquid activation device B12 will be specifically described.

(Configuration of First Liquid Activation Portion Having Permanent Magnet)

A specific configuration of the first liquid activation portion B51 will be described with reference to FIGS. 5 to 7.

In FIG. 6, reference symbol B1 denotes the flow path, reference symbol B2 denotes the permanent magnet, reference symbol B4 denotes the concave type yoke, reference symbol B5 denotes a leading end portion of the concave type yoke B4, reference symbol B6 denotes a displacement at the leading end of the concave type yoke B4, reference symbol B7 denotes the direction of the lines of magnetic force, reference numeral B8 is the direction of the flowing water, reference numeral B9 denotes the direction of the electromotive current, and reference numeral B10 denotes the nonmagnetic conductive metal layer.

The permanent magnets B2 are disposed so as to face each other so that the pole and the S pole face each other having the flow path B1 interposed therebetween, and the concave type yokes B4 molded with the magnetic metal or the magnetic ceramic are covered over and adhered to the permanent magnet B2. The concave type yokes B4 face each other, and both ends of the concave type yoke B4 have a gap not to come into contact with each other.

In this way, since one side of the permanent magnet is joined to the concave type yoke B4, the pole on the side joined to the concave type yoke B4 is displaced to an end of the gap side, and the N pole B6 and the S pole B6 displaced on the leading end of the concave type yoke B4 are attracted to each other, such that a magnetic circuit can be configured to prevent the lines of magnetic force from being leaked to the outside of the concave type yoke B4.

With such a configuration, if the flowing water passes through the lines of magnetic force in a direction of arrow B8, an electromotive current is generated to the left and right in a direction of arrow B9 in the direction orthogonal to the flowing water.

Since intensity E of the electromotive current is proportional to a magnetic flux density B and a flow velocity V of the flowing water, the intensity E can be expressed by the following expression.

E=kBV

Here, E is the intensity of the electromotive current, k is a constant, B is the magnetic flux density, and V is the flow velocity of the flowing water.

The electromotive current thus generated is inductively charged not to cause a discharge loss, and electrons generated by the charging are efficiently emitted in the flowing water, such that the nonmagnetic conductive metal layer B10 is provided inside the concave type yoke B4. The nonmagnetic conductive metal layer B10 is plated with metals having a high potential, or copper, silver, and gold alone belonging to an IB group in a periodic table of elements or composites of these metals, or constituted by a composite metal plate to which a thin plate of these metals is bonded. Since the nonmagnetic conductive metal layer B20 has the property of pushing the lines of magnetic force in the central direction, the central lines of magnetic forces are densified, the magnetic flux density B is increased, the generation of the electromotive current is increased, and the generated electromotive current is interrupted and thus cannot pass through the nonmagnetic conductive metal layer B10.

In addition, since the nonmagnetic conductive metal layer B10 has a potential higher than that of the magnetic metal or the magnetic ceramic which forms the concave type yoke B4, the potential inside the nonmagnetic conductive metal layer B10 on the central side is further increased due to the contact cell action, and the generated electrons are repelled and more efficiently emitted into the flowing water.

When the nonmagnetic conductive metal layer B10 is constituted by the composite plating or the composite metal plate, the nonmagnetic conductive metal layer B10 has a structure in which metals having a high potential and metals having a low potential are bonded, such that the metal side having a high potential becomes the flow path B1 side. This further promotes the emission of electrons.

Since oxygen configuring a part of water molecules (H₂O) is an electron acceptor, the electrons emitted into the flowing water serve to increase bipolarity of water by imparting an electric charge to the oxygen. As a result, a bonding angle of a hydrogen atom becomes wider, an aggregate density between water molecules is increased and thus a water molecule aggregate (cluster) becomes smaller, and the flowing water takes a negative electric charge and decreases an oxidation reduction potential to become reduced water, thereby promoting the activation of water.

Although the occurrence of clusters is caused by the hydrogen bonding, when electrons are rich, electrons in oxygen atoms of water molecules and free electrons repel each other, and when the repulsive force is larger than the bonding force of van der Waals' water, the hydrogen bond is broken, the cluster becomes fine, and a Brownian motion of the water molecules becomes active. At the same time, the electrons emitted in the flowing water are charged to dissolved oxygen in water to produce oxygen anions (O+e⁻→O⁻), which react with water to form hydroxyl radicals (O⁻+H₂O=2OH), such that the treated water is weakly alkalized.

As a result, with the use of the water activation device, the magnetic activation by the permanent magnet and the electrochemical activation by electrons are performed, and by the synergistic action of the magnetic force and the electrons, much better activation is performed than the activation method only by the magnetic force.

(Configuration of Second Liquid Activation Portion Including UV Lamp)

Next, a specific configuration of the second liquid activation portion B52 will be described with reference to FIG. 5.

The second liquid activation portion B52 is provided with the ultraviolet (UV) lamp B71 for applying ultraviolet rays to the liquid flowing through the flow path B1. The UV lamp B71 is an example of ultraviolet ray irradiation means.

The UV lamp B71 includes a base portion B72 and an ultraviolet ray irradiation portion B73. The ultraviolet ray irradiation portion B73 includes a glass tube, an electrode provided inside the glass tube, or the like. The UV lamp B71 having such a configuration is attached so that the base portion B72 is exposed to the outside of the flow path B1 and the ultraviolet ray irradiation portion B73 is positioned inside the flow path B1. In other words, the UV lamp B71 is fixed to the outlet B62 side of the flow path B1 in a state in which the ultraviolet ray irradiation portion B73 is inserted into the flow path B1.

The liquid flowing in the direction of the outlet B62 in the flow path B1 flows in a space (space in the ring shape in a cross section) around the glass pipe of the ultraviolet ray irradiation portion B73 in the second liquid activation portion B52. At that time, the ultraviolet rays emitted from the ultraviolet ray irradiation portion B73 irradiate the liquid flowing therearound. As described in Examples to be described later, it is considered that the oxidation-reduction potential of the liquid is greatly decreased as the liquid flowing in the flow path B1 is irradiated with the ultraviolet rays.

The size, shape and wattage of the usable UV lamp are not particularly limited. However, as described in Examples to be described later, since the oxidation-reduction potential tends to be decreased when the wattage of the UV lamp is high, it is preferable that the wattage of the UV lamp is high.

When the liquid such as the water and the cleaning liquid is activated using the above-described liquid activation device B12, at first, as shown in FIG. 5, at least a pair of permanent magnets B2 is disposed to face each other, having the flow path B1 interposed therebetween, and the ultraviolet ray irradiation portion B73 of the UV lamp B71 is disposed in the flow path B1. Subsequently, the liquid flows through the flow path B1 using the pump or the like, and the liquid flowing through the flow path is irradiated with ultraviolet rays. In the course of flowing through the flow path B1, the liquid is subjected to the magnetic treatment, and the liquid irradiated with the ultraviolet rays becomes the activated liquid and is discharged from the liquid activation device B12.

(Pretreatment of Coating)

When the coating is applied to the coating object (structure) such as the body of the vehicle and the outer wall of the building using the above-described coating device, it is preferable to perform the “cleaning treatment” on the coating object prior to the coating. In other words, the object is subjected to the “cleaning treatment” in advance, and thereafter, it is preferable to perform the coating on the object (a structure whose dirt such as mold and oil is removed by the cleaning treatment) using the coating device.

The above-described “cleaning treatment” includes the cleaning process of cleaning the coating object with the cleaning liquid agent.

(Cleaning Treatment/Cleaning Process)

In the “cleaning process”, the coating object is cleaned with one or more cleaning liquid agents selected from the group consisting of the following (1) to (4).

(1) A cleaning liquid agent containing s odium hypochlorite sodium hydroxide, sodium carbonate, a nonionic surfactant, and glycine and having a pH of 8 to 12.

(2) A cleaning liquid agent containing sodium hydrogen fluoride and a chelating agent and having a pH of 4 to 6.

(3) A cleaning liquid agent containing sodium hypochlorite and sodium carbonate, not containing sodium hydroxide and having a pH of 8 to 2.

(4) A cleaning liquid agent containing a nonionic surfactant, an alkali builder, a chelating agent, and a metal sequestering agent (excluding the alkali builder) and having a pH of 8 to 12.

The cleaning quid agent (1) contains sodium hypochlorite, sodium hydroxide, sodium carbonate, a nonionic surfactant, and glycine and has a pH of 8 to 12, preferably a pH of 8 to 10. Due to the synergistic effect of the constituents, the cleaning liquid agent (1) has high sterilization decomposition characteristics and has an effect of peeling off dirt adhering to the coating object, such that excellent cleaning effect for the overall dirt of the coating object is shown.

The cleaning liquid agent (1) may optionally contain ingredients other than those described above, and can preferably contain, for example, a thickener, an antifoaming agent, and the like.

Examples of the nonionic surfactant in the cleaning liquid agent (1) may include fatty acid esters, glycerin fatty acid esters, sorbitan fatty acid esters, sucrose fatty acid esters, alkylphenol fatty acids, polyhydric alcohol fatty acid esters, fatty acid alkanolamidoalkyl polyglucosides, and the like.

In addition, examples of the thickeners preferably contained in the cleaning liquid agent (1) include arginine⋅carbomer (carboxyvinyl polymer), sodium alginate, propylene glycol alginate, ethyl cellulose, sodium carboxymethyl cellulose, sodium glycolate, synthetic sodium magnesium silicate, dimethyl distearyl ammonium hectorite, sodium polyacrylate, and the like.

The cleaning liquid agent (1) can be prepared as an aqueous solution in which each ingredient is mixed at a ratio corresponding to a desired action, and is not limited, but specifically, is preferably an aqueous solution which contains 2.0 to 5.0 parts by weight of sodium hypochlorite, 0.4 to 0.6 parts by weight of sodium hydroxide, 0.4 to 0.6 parts by weight of sodium carbonate, 0.4 to 1.0 parts by weight of a nonionic surfactant, about 0.4 to 0.6 parts by weight of glycine as composition ratios. In addition, when the cleaning liquid agent (1) contains the thickener and the antifoaming agent, the cleaning liquid agent (1) can preferably contain about 0.05 to 0.15 parts by weight of the thickener and 0.05 to 0.15 parts by weight of the antifoaming agent as well as the ingredients having the compositions of each part by weight.

The cleaning liquid agent (2) contains sodium hydrogen fluoride and a chelating agent and has a pH of 4 to 6. The cleaning liquid agent (2) exhibits high cleaning properties and effectively removes dirt due to rust or efflorescence (whitening) and the like. The cleaning liquid agent (2) can contain other ingredients within a range not hindering its action.

Examples of the chelating agent in the cleaning liquid agent (2) may include ethylenediaminetetraacetic acid (EDTA), nitrilotriacetic acid (NTA), citric acid, etidronic acid (hydroxyethanediphosphonic acid), L-aspartic acid diacetate (ASDA) L-glutamic acid diacetate (GLDA), and the like. In the cleaning liquid agent (2), it is also preferable to use two or more of these chelating agents in combination, and it is particularly preferable to use a combination of EDTA and other chelating agents.

The cleaning liquid agent (2) can be prepared as an aqueous solution in which each ingredient is mixed at a ratio corresponding to the desired action, and is not limited, but specifically, is preferably an aqueous solution which contains 2.0 to 8.0 parts by weight of sodium hydrogen fluoride, 1.0 to 2.0 parts by weight of EDTA, and about 0.4 to 0.6 parts by weight of chelating agents other than EDTA as combination ratios.

The cleaning liquid agent (3) contains sodium hypochlorite and sodium carbonate, not containing sodium hydroxide and has a pH of 8 to 12, preferably a pH of 8 to 10. Since the cleaning liquid agent (3) exhibits high sterilizing and cleaning properties and does not decompose cellulose of wood or the like by not containing sodium hydroxide, the cleaning liquid agent (3) can be suitably used to clean a structure using biologically derived materials such as wood. The cleaning liquid agent (3) can contain other ingredients within a range not hindering its action.

The cleaning liquid agent (3) can be prepared as an aqueous solution in which each ingredient is mixed at a ratio corresponding to the desired action, and is not limited, but specifically, is preferably an aqueous solution which contains 1.0 to 4.0 parts by weight of sodium hypochlorite and about 0.4 to 0.6 parts by weight of sodium carbonate as composition ratios.

The cleaning liquid agent (4) contains a nonionic surfactant, an alkali builder, a chelating agent, and a metal sequestering agent (excluding the alkali builder) and has a pH of 8 to 12, preferably 8 to 10. The cleaning liquid agent (4) exhibits high cleaning properties, and effectively removes dirt due to oil or the like and dirt due to rust. The cleaning liquid agent (4) can contain other ingredients within a range not hindering its action.

As the nonionic surfactant in the cleaning liquid agent (4), for example, the nonionic surfactant exemplified in the cleaning liquid agent (1) can be preferably used. In addition, as the chelating agent, the chelating agent exemplified in the cleaning liquid agent (2) can be preferably used.

In addition, examples of the alkaline builder in the cleaning liquid agent (4) may include sodium phosphate, sodium hydrogen phosphate, sodium silicate, and the like. In addition, examples of the metal sequestering agent may include sodium aluminum silicate, aluminosilicate, citric acid, tripolyphosphate, pyrophosphate, and the like.

The cleaning liquid agent (4) can be prepared as an aqueous solution in which each ingredient is mixed at a ratio corresponding to the desired action, and is not limited, but specifically, is preferably an aqueous solution which contains 11.0 to 13.0 parts by weight of the alkali builder, 10.0 to 12.0 parts by weight of the nonionic surfactant, 0.4 to 0.6 parts by weight of the chelating agent, and about 0.2 to 0.4 parts by weight of the metal sequestering agent as combination ratios.

Since any of these cleaning liquid agents does not usually contain cadmium and its compounds, lead and its compounds, hexavalent chromium compounds, arsenic and its compounds, cyanide compounds, and mercury and other mercury compounds, it is possible to keep wastewater when washed with water after using the cleaning liquid below the wastewater environmental standard.

In the “cleaning process”, one or more of the above-described cleaning liquid agents is selected and used according to the state of dirt such as the kind and degree of dirt of the structure to be cleaned, the material and shape of the structure, and the like.

In many cases, the dirt of the coating object is complex dirt, and often includes dirt due to fungi (mold) or bacteria. The dirt due to fungi or bacteria is often dirt formed by turbidity of a plurality of fungi or bacteria.

The inventors found that when fungi adhere to a structure, static electricity is generated when hyphae are released from the spores, impurities are adsorbed on the hyphae by the electrostatic action, and complex dirt is easily formed. Therefore, in particular, in a structure having complex dirt including fungi, it is possible to easily remove other dirt attached to the hyphae by removing fungi.

It is preferable to have a process of recognizing the dirt of the structure prior to the “cleaning process” of cleaning the structure with the cleaning liquid agent. By recognizing the dirt of the structure to be cleaned, it is possible to judge the kind, concentration, use time, treatment method, cleaning time, combination, and the like of the optimum cleaning liquid agent, thereby making it possible to perform more appropriate cleaning.

The recognition of dirt can be performed by any method which can recognize the kind, degree, and the like of dirt. Examples of the method may include analysis from a sample of dirt ingredient, recognition of a color tone by visual inspection, gloss and the like, sensory recognition by odor or touch, and the like. In the sensory recognition, comprehensive judgment from tendency of dirt judged from the materials of the structure and information such as color tone, odor, and touch is effective. In addition, a food stamping method is effective for recognizing the state, such as the kind and composition of fungi or bacteria.

In the “cleaning process”, it is preferable to recognize what kind of dirt the structure as the cleaning object has and to select and use the cleaning liquid agent based on the recognition. That is, when the structure has the dirt due to fungi and bacteria, it is preferable to use the cleaning liquid agent (1) or (3), and it is preferable to use the cleaning liquid agent (1) since the cleaning effect is more increased.

In addition, when the structure has the dirt due to fungi, bacteria, and rust, it is preferable to use the cleaning liquid agents (1) or (3) and (2), and it is preferable to use the cleaning liquid agents (1) and (2).

In addition, when the structure has the dirt due to fungi, bacteria, rust, and oil, so is preferable to use the cleaning liquid agents (1) or (3), (2), and (4), and it is more preferable to use the cleaning liquid agents (1), (2), and (4).

In addition, when the structure has the dirt due to fungi, bacteria, and oil, it is preferable to use the cleaning liquid agents (1) or (3) and (4), and it is more preferable to use the cleaning liquid agents (1) and (4).

However, in the use of the cleaning liquid agents, when the structure is made of wood, it is preferable to use the cleaning liquid agent (3) instead of the cleaning liquid agent (1) from the viewpoint of preventing the materials of the structure from deteriorating.

Further, in the “cleaning process”, prior to the cleaning of the entire object to be cleaned, a part of the structure to be cleaned is subjected to test cleaning, and from the result of the test cleaning, it is preferable that the kind, concentration, amount, combination, or the like of the effective cleaning liquid agent is selected to clean the entire object portion.

In the “cleaning process”, each cleaning liquid agent can be used by adjusting its own ingredient composition and concentration according to the kind and degree of dirt, the material and shape of the structure, the workability in the cleaning process, and the like. Further, the “cleaning process” can be performed by adjusting the use amount of the cleaning liquid agent and cleaning time according to the kind and degree of dirt. In addition, when using two or more kinds of cleaning liquid agents, the order of using the cleaning liquid agents is not limited. In addition, in the case of using two or more kinds of cleaning liquid agents, each of the cleaning liquid agents may be used, followed by the water washing process, a drying process may be included, and the water washing process and the drying process may be included. In addition, in the “cleaning process”, among the four kinds of cleaning liquid agents, a combination of two or more kinds of cleaning liquid agents belonging to the same kind of cleaning liquid agent and having different composition, concentration, or the like may be used. Further, in the “cleaning process”, the same cleaning treatment may be performed a plurality of times.

The “cleaning process” is performed using the cleaning liquid agent, but specifically, a desired amount of cleaning liquid agent having a desired concentration and composition is brought into contact with the structure to be cleaned by methods such as application and spraying. The contact between the structure and the cleaning liquid agent is preferably performed for a period of time to sufficiently decompose, dissolve, separate, or peel off the dirt of the structure, and depends on the conditions such as the material, shape, kind, and degree of dirt of the structure, but it is preferable that the contact time is usually 5 minutes or more, preferably 20 minutes or more, and more preferably 30 minutes or more. Further, in the “cleaning process”, it is preferable to wash the cleaning liquid agent in contact with the structure with water

In the “cleaning process”, it is preferable to perform water washing to remove the cleaning liquid agent from the structure at least after the final cleaning using the cleaning liquid agent, and it is more preferable to perform water washing and drying.

Each of the cleaning liquid agents used in the cleaning treatment may contain other ingredients within the range in which the action is not impaired and may include, for example, a perfume, a coloring agent, or the like, and may be used by being adjusted to a desired concentration. In addition, each of the above-described cleaning liquid agents can be appropriately prepared and selected according to the dirt state, material, shape, desired imparting property, and the like of the structure to be cleaned, and can be used in combination as necessary.

In the cleaning treatment, it is possible to highly clean the structure with a simple process, such that even when the cleaning treatment is performed on large structures, such as an outer wall surface of a building, the cleaning treatment can be economically performed only by facilities which can apply or spray the cleaning liquid agent to installation locations.

### EXAMPLE 1

Next, specific examples of the present invention will be described.

Using the four kinds of liquids shown in Table 1, the coating treatment was performed on the coating object, and the difference in the effect of suppressing dirt by the coating was verified.

TABLE 1

Example 1
Comparative Example 1
Comparative Example 2
Comparative Example 3
Comparative Example 4
Liquid used in coating treatment
Liquid obtained by circulating coating liquid preparing device
including both of cylinder device and liquid activation device
(coating liquid prepared by the present invention)
Liquid obtained by circulating cylinder device
Liquid obtained by circulating liquid activation device
Tap water
No (leave without coating)

In Example 1, the liquid obtained by repeatedly circulating tap water into the coating liquid preparing device equipped with both of the cylinder device and the liquid activation device, that is, the coating liquid preparing device according to the present invention shown in FIG. 1 was used as the coating liquid.

In Comparative Example 1, the quid obtained by repeatedly circulating the tap water into only the cylinder device described in the above embodiment was used as the coating liquid.

In Comparative Example 2, the liquid obtained by repeatedly circulating the tap water into only the liquid activation device described in the above-described embodiment was used as the coating liquid.

In Comparative Example 3, only the tap water (tap water not subjected to any treatment) was used as the coating liquid.

In Comparative Example 4, no liquid was used.

(Experimental Method)

In experiments, a wall body (that is, weather-beaten wall body) which was uniform in shade over the entire surface and constantly exposed to the outside air was used. The wall body used in Experiment 1 was a wall-like structure made of concrete, and had a size of a length of about 1.5 m, a width of about 6 m, and a thickness of about 35 cm.

The wall body was equally divided into five sections in a lateral direction and the coating treatment was performed by spraying the liquid of Example 1, the liquid of Comparative Example 1, the liquid of Comparative Example 2, and the liquid of Comparative Example 3 in order from the left. Prior to the coating treatment, the cleaning treatment using the above-described cleaning liquid agent was performed. Since Comparative Example 4 was an experimental example without using the liquid, the liquid was left (neither cleaning nor coating was performed).

When the cleaning treatment is performed, the entire surface of the wall body was cleaned with the same cleaning liquid agent to remove the dirt such as mold and oil, and thereafter, the coating treatment was performed on the surface of the wall body from which the dirt was removed.

When the coating treatment was performed by spraying the liquid onto the wall body, in Example and each Comparative Example, 50 L of the liquid was sprayed. In addition, when spraying the liquid onto the wall body, the liquid was covered with a waterproof sheet so that the liquid did not reach the adjacent section (section of another Example or Comparative Example).

After spraying the liquid onto the entire surface of the wall body in the above procedure, the wall body was left for a certain period of time while being exposed to the outside air, and the state of progress of the dirt was visually confirmed.

(Experiment Result 1)

When the wall body was left for one year, the dirt state of each section of the wall body was visually evaluated.

The most severely dirt section was a section in which the liquids of Comparative Example 3 and Comparative Example 4 were sprayed, in which darkening occurred over the entire surface of the liquid spraying surface and the dirt severely proceeded over the entire surface. The darkening adhering to the wall body was thought to be caused by mold, exhaust gas, and the like.

The second most severely dirt section was a section in which the liquids of Comparative Example 1 and Comparative Example 2 were sprayed, and the dirt state was slightly less than that of Comparative Example 3 or Comparative Example 4, but mottled, dropped, and banded darkening frequently occurred and the dirt severely proceeded over the entire surface or the liquid sprayed surface.

The progress of the dirt was most suppressed in Example 1. No darkening was found in the section in which the liquid of Example 1 was sprayed, and the wall surface onto which the liquid was sprayed kept substantially the same cleanliness and shade as those at start of the experiment (at the time of spraying the liquid one year ago).

(Experiment Result 2)

Continuing the above-described experiment, when the wall body was left for two years, the dirt state of each section of the wall body was visually evaluated.

The occurrence of dirt (occurrence of darkening or the like) in the section in which the liquids of Comparative Examples 1 to 4 were sprayed was further progressed, and the difference in the dirt between Example 1 and Comparative Examples 1 to 4 became more remarkable.

In addition, in the section in which the liquid of Example 1 was sprayed, a slight color change due to the influence of ultraviolet rays or the like for two years was observed, but darkening was not found, and the surface coated by spraying the liquid kept the shade and cleanliness close to those at the start of the experiment (at the time of spraying the liquid two years ago).

From the above experimental results, it can be confirmed that the coating liquid is prepared according to the present invention and the surface of the vehicle or the outer wall and the like are coated with the coating liquid, such that it can be confirmed that the progress of the dirt due to mold or the like can be greatly suppressed.

### EXAMPLE 2

The coating treatment was performed on the coating object using the four kinds of liquids shown in the above Table 1, and the difference in specific effect of dirt removal (easily removing dirt) was verified.

(Experiment Method)

In the experiment, 5 iron plates of the same size and shade were used. Each iron plate had a size of length of about 60 cm, a width of about 40 m, and a thickness of about 1 cm.

The coating treatment was performed by individually spraying the liquid of Example 1, the liquid of Comparative Example 1, the liquid of Comparative Example 2, and the liquid of Comparative Example 3 onto the prepared iron plate. Prior to the coating treatment, the cleaning treatment using the above-described cleaning liquid agent was performed. Since Comparative Example 4 was an experimental example without using the liquid, the iron plate was left as it was (neither cleaning nor coating was performed).

When the cleaning treatment was performed, the entire surface of the iron plate was cleaned with the same cleaning liquid agent to remove the dirt such as mold and oil, and thereafter the coating treatment was performed on the surface of the iron plate from which the dirt was removed.

When the coating treatment was performed by spraying the liquid onto the iron plate, in Examples and each Comparative Example, 30 L of liquid was blown.

After the liquid was sprayed onto the entire surface of the iron plate in the above procedure, the iron plate was left as it was in the state in which it was exposed to outside air for a certain period of time, and then high-pressure cleaning was performed to visually confirm the removal of dirt (easily removing the dirt).

(Experiment Result)

When the iron plate was left for one year, each iron plate was high-pressure cleaned with tap water, and the removed state of dirt (easily removing the dirt) was visually evaluated.

The dirt state of the iron plate after the iron plate was left for one year was about the same as the dirt state of the wall body in the above-mentioned example. That is, the most dirty object was the iron plate of Comparative Example 4, and the state in which the progress of the dirty was least was Example 1.

Since the high-pressure cleaning using tap water was performed on each iron plate, it was confirmed that in the iron plate of Example 1 having the least dirt, the dirt due to the black mold or the like was easily removed in the shortest time. That is, it can be confirmed that the dirt such as black mold can be easily removed by the coating effect.

From the above experimental results, it can be confirmed that the coating liquid is prepared according to the present invention and the surface of the vehicle or the outer wall and the like is coated with the coating liquid, such that it can be confirmed that the dirt such as the attached mold can be easily removed without trouble.

### REFERENCE SIGNS LIST

1 Coating liquid preparing device
5 Horizontal type cylinder device
6 Vertical type cylinder device
8 Liquid activation device
12 Connection flow path
21 Pump
23, 24 Circulation flow path
26 Tank
31 Liquid ejection device
33 Pump
35 Ejection nozzle
A1 Cylinder device
A2 Liquid ejection pipe
A3 Liquid inlet
A4 Liquid outlet
A5 Liquid ejection hole
A6, A7, A14 Filter (mesh network)
A8 Ceramic composite
A9 Water flow
A10 Ejection pipe
A11 Water flow meter
A12 Liquid circulation device
A13 Pump
A15 Switching valve
A16 Hose or liquid pipe
A17 Concentrated circulating water
A18 Mop
A19 Liquid container
A20 Automatic floor covering machine
A21 Lid
A22 Rotating brush
A23 Moisture absorbing member
A24 Manual wheel
A25 Wheel
A26 Motor
A27 Handle or hand grip
A28 Floor surface
B1 Flow path (water flow pipe)
B2 Permanent magnet
B4 Concave type yoke
B5 Leading end portion of concave type yoke
B6 Displacement of leading end of concave type yoke
B7 Direction of lines of magnetic force
B8 Direction of flowing water
B8 Direction of electromotive current
B10 Nonmagnetic conductive metal layer
B11 Housing
B14 Water tank
B15 Water tank
B16 Raw water
B17 Rigid polyvinyl chloride pipe
B18 Pump
B51 First liquid activation portion (magnetic processing portion)
B52 Second liquid activation portion (ultraviolet ray irradiation portion)
B61 Inlet
B62 Outlet
B71 UV lamp (ultraviolet lamp/ultraviolet ray irradiation means)
B72 Base portion
B73 Ultraviolet ray irradiation portion

1. A coating liquid preparing device comprising:
a cylinder device in which a liquid as a source of a coating liquid to be prepared flows; a liquid activation device in which the liquid flows; and a connection flow path which connects one of the cylinder device and the liquid activation device to the other of the cylinder device and the liquid activation device,
wherein the cylinder device includes a cylindrical body whose both ends are closed, filters are respectively disposed near both ends of the cylindrical body inside the cylindrical body, ceramic composites are provided between the filters, a liquid ejection pipe that penetrates through the filter near one end of the cylindrical body is provided at one end of the cylindrical body, a liquid outlet is provided at the other end of the cylindrical body, and the liquid ejection pipe has a liquid inlet, and
the liquid activation device has a flow path through which the liquid flows, at least a pair of permanent magnets that is provided so as to face each other, having the flow path interposed therebetween, and an ultraviolet ray irradiation means that emits ultraviolet rays onto the liquid flowing through the flow path.

2. The coating liquid preparing device according to claim 1, wherein in the cylinder device, the cylindrical body whose both ends are closed has the liquid outlet and the liquid inlet, and the filters are provided on the liquid outlet and the liquid inlet.

3. The coating liquid preparing device according to claim 1, wherein in the liquid activation device, an ultraviolet ray irradiation portion of the ultraviolet ray irradiation means is disposed within the flow path.

4. The coating liquid preparing device according to claim 1, wherein a pump and circulation flow paths which circulate a liquid into the cylinder device and the liquid activation device which are connected by the connection flow path are provided.

5. A coating device, comprising:
the coating liquid preparing device according to claim 1; and
a liquid ejection device which sprays a coating liquid prepared by the coating liquid preparing device onto a coating object.

6. A coating device, comprising:
the coating liquid preparing device according to claim 2; and
a liquid ejection device which sprays a coating liquid prepared by the coating liquid preparing device onto a coating object.

7. A coating device, comprising:
the coating liquid preparing device according to claim 3; and
a liquid ejection device which sprays a coating liquid prepared by the coating liquid preparing device onto a coating object.

8. A coating device, comprising:
the coating liquid preparing device according to claim 4; and
a liquid ejection device which sprays a coating liquid prepared by the coating liquid preparing device onto a coating object.
